(19) United States
(12) Patent Application Publication
(10) Pub. No.: US 2017/0028517 A1
(43) Pub. Date: Feb. 2, 2017

(54) AXLE WELDING ALIGNMENT PLATES AND METHOD FOR USING THE SAME

(71) Applicant: William J. Ferrari, Pittsburgh, PA (US)

(72) Inventor: William J. Ferrari, Pittsburgh, PA (US)

(21) Appl. No.: 15/219,181

(22) Filed: Jul. 25, 2016

Related U.S. Application Data
(60) Provisional application No. 62/196,168, filed on Jul. 23, 2015.

(51) Int. Cl. B23P 6/04; B23K 37/053

(52) U.S. Cl. CPC B23P 6/04; B23K 37/0533; B23K 37/0538

(57) ABSTRACT

A set of alignment plates is provided for adjusting the relative location of the two ends of a vehicle axle with respect to one another prior to the commencement of a welding repair thereon. A first alignment plate clamps to a first jig element and a second alignment plate affixes to an axle component at the opposed (hub) end, both alignment plates being sequentially numbered or lettered and rotatable until proper alignment is achieved.

### CROSS-REFERENCE TO RELATED APPLICATION

This is a perfection of provisional application Ser. No. 62/196,168 filed on Jul. 23, 2015, the disclosure of which is fully incorporated by reference herein.

### TECHNICAL FIELD

This invention relates to vehicular axle repair methods and apparatus improvements relating to the same. They are intended as further advancements from my original disclosures in U.S. Pat. Nos. 4,792,080 and 5,125,146. These improvements are applicable to trailer axle repairs and certain drive axles with welded on brake spiders. They can be used to repair an axle in a welding repair shop OR at the actual axle failure site.

### BACKGROUND OF THE INVENTION

It is known to make a welded jig to temporarily hold a replacement terminal portion in place with respect to the remainder of an axle, until the terminal portion has been partially welded to the remainder of the axle at the joint between them. That welded jig is composed of two inner adapters (instead of bearing races) held together by four struts welded between them. The adapters are of a size appropriate for fitting on the inner and outer bearing surfaces of the axle. The terminal portion is initially welded to the remainder of the axle through the access to the joint provided by the spaces between the struts. The jig is then removed and the finish welding done.

The foregoing technique has been more time consuming on trailers or axles with welded spiders. Even when manufactured with the races in place on a good axle, there is always distortion and non-alignment of the races with respect to one another caused by the process of welding the struts to the races. This necessitates having to force the jig during placement and removal.

In my earlier patents from the late 1980's, I showed using a special jig to weld an outer bearing surface replacement part to a vehicle axle and a related method. That disclosure taught using an undamaged inner bearing surface for determining proper alignment of the outer bearing surface replacement part.

### SUMMARY OF THE INVENTION

It is an object of this invention to provide solutions suitable for axle repairs where more than the outer bearing surface has been damaged. It is another object to enhance the devices and methods used for repairing trailer axles and some drive axles with welded brake spiders.

In this invention, an alignment plate or platform is provided which has means for adjusting its location with respect to the axis of the vehicle axle. The alignment plates assist with setting a proper positive camber and toe. The alignment means include clamping a first alignment plate to a first jig element and affixing a second alignment plate at an opposed end of the welding set up with both alignment plates being sequentially numbered or lettered and rotatable until a proper alignment is achieved before welding commences.

In addition, gauges aid in the adjustment for locating the alignment platform with respect to the axle, trailer, drive or both types. With the alignment platform properly located, a replacement part is properly held in place for welding. It represents a time and labor savings when effecting a welding repair to a vehicular (truck or automotive) axle. Prior welding alignment means included adding a crude locator stick (item S in FIG. 1) on one of the repair ends, moving back and forth about the whole length of a set up axle for repair (could be six to eight feet in length) and then sometimes visually estimating an alignment with that locator stick before the welding repair commences.

### BRIEF DESCRIPTION OF THE DRAWINGS

FIG. 1 is a left side perspective view of an old (or prior art) trailer axle jig design prior to these inventions;

FIG. 2 is a left side perspective view of a trailer axle jig that shows some of the jig improvements to which this invention pertains; and

FIG. 3 is a close up enlargement of circle E from FIG. 2 focusing on one representative clamp arrangement according to this invention.

### PREFERRED EMBODIMENTS OF THE INVENTION

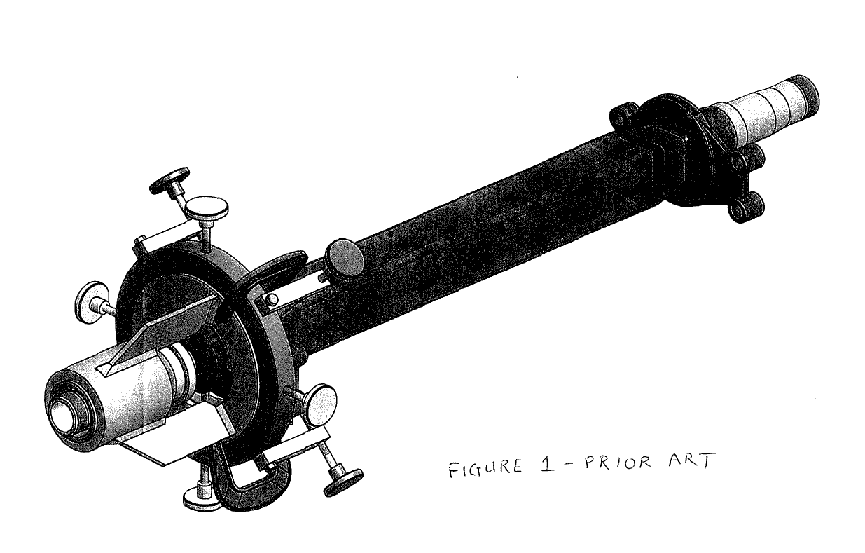

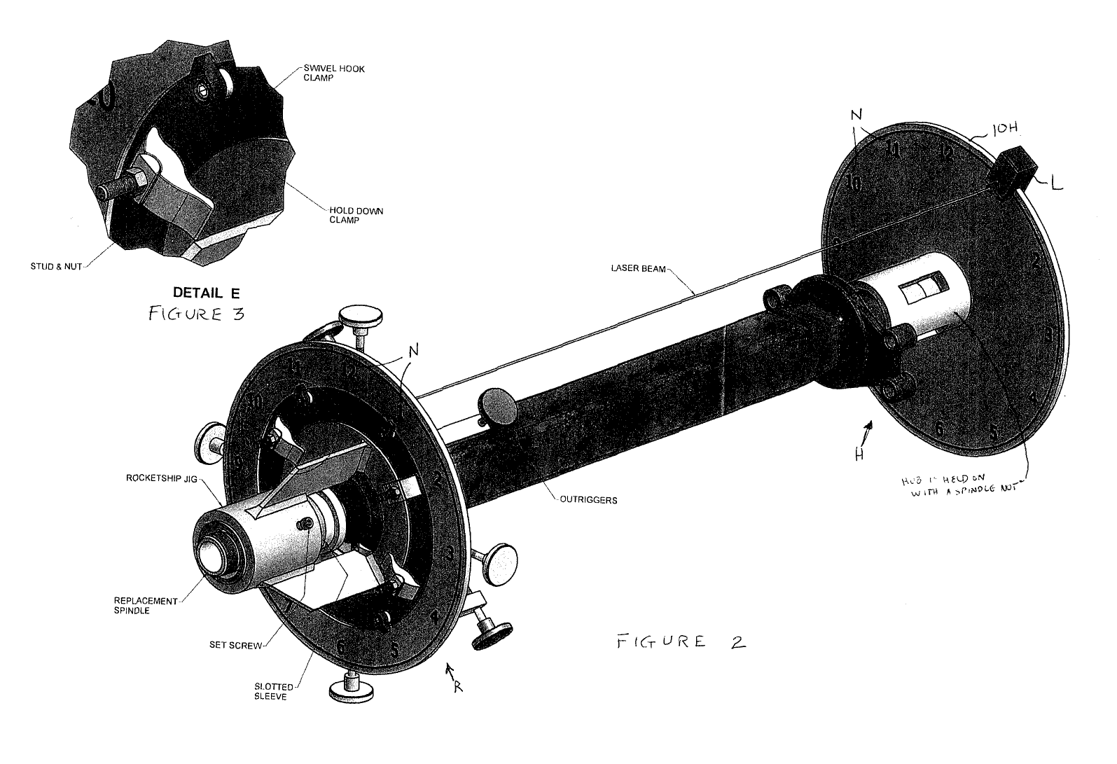

FIGS. 1 through 3 illustrate by comparison one old (FIG. 1) versus new (FIGS. 2 and 3) trailer axle jig arrangement, the latter two employing one preferred embodiment of this invention. As is evident in FIG. 1, trailer axle jigs prior to this invention had no outside clamping mechanisms (which is better seen in the enlarged focus view of FIG. 3). The swivel clamps of this invention, by contrast, hold the jig with its recessed plate for better alignment with gauges that include laser components and more accurate, more ideal proper positioning brackets. The latter lets an operator align the two ends in a weld repair situation, i.e., the replacement spindle end R versus the opposed hub and spindle nut end H. The two alignment plates, 10R and 10H, include numerical indicators N so as to appear like the face of a clock (hence the time notations at 1 o'clock through 12 o'clock). Alternately, the faces of one or both alignment plates may be sequentially lettered (not shown), from “A” to “N”, for example, or roughly thereabouts.

Such alignment plates attach to the thread and journal jig components of this set of axle repairing improvements. One alternative to the aforementioned use of a laser addition L aligner (of FIG. 2) would be an implementable, manual measuring device/separator such as a retractable measuring tape or tape roller (not shown).

Another inventive aspect as shown in FIG. 2 concerns the addition of at least one (and maybe two or more) set screws along the slotted sleeve of this new and improved rocket ship jig. Such set screws serve to act as a pseudo spindle “break”.

The same improvements for the foregoing trailer axle, particularly the use of rocker clamps, and a spindle break (i.e., the added “window”) will help improve the repeated manufacture (virtually every time one is needed) of a customized axle jig according to alternate embodiments of this invention.

In the case of the solid axles used in trailers, the replacement is held in abutment with the remainder of the axle manually. An external clamp may be designed for this purpose. Rarely for solid trailer axles is the fit of the jig and bushings tight enough that manual holding of the jig and replacement becomes unnecessary.

Returning now to FIG. 2, one can see the use of a gauge with a light source, such as a laser light L, in order for the jig to be placed coaxially onto the good inner and outer bearing surfaces at the other end (hub side H) of the axle at the same radial distance from the bearing surface axis as the gauge from the axis of its ring. A sensor, which may be a human, then detects when the sighting bores are aligned to pass light from the light source. The operation of adjusting translator and tilt bolts will best be done with a replacement portion not yet in place that will make turning of these bolts easier.

Gauges may be used in the case of bearing surfaces that are set at some angle with respect to the axle axis for introducing a desired amount of camber to the wheels. In this case, the sighting bores are correspondingly rotated amounts equal to the camber before carrying out the sighting.

What is claimed is:

1. An alignment assist device for use with a jig to weld repair a vehicle axle, said alignment assist device comprising:
(a) a first component for clamping to a spindle replacement end of the vehicle outward of a plurality of outrigger clamps for holding the vehicle axle during weld repair; and
(b) a second component for affixing to a hub end of the vehicle axle opposite the spindle replacement end, said first component and said second component having commonly spaced markings on at least one face of the first component and one face of the second component for an operator to rotate at least one of the first component and the second component until the two components are sufficiently aligned.

2. The alignment assist device of claim 1 wherein the first component has commonly spaced markings on both an inward face and an outward face.

3. The alignment assist device of claim 1 wherein the second component has commonly spaced markings on both an inward face and an outward face.

4. The alignment assist device of claim 1 wherein the commonly spaced markings on the first component and the second component are numbered sequentially.

5. The alignment assist device of claim 4 wherein the commonly spaced markings on the first component and the second component are numbered similar to that of a clock face with twelve hour indicators.

6. The alignment assist device of claim 1 wherein the commonly spaced markings on the first component and the second component are lettered sequentially.

7. The alignment assist device of claim 1, which further includes an indicating connector between the commonly spaced markings of the first component and the second component.

8. The alignment assist device of claim 7 wherein the indicating connector is selected from the group consisting of an extendible measuring tape and a laser pointer.

9. The alignment assist device of claim 1 wherein the vehicle axle is a trailer axle or a drive axle with a welded brake spider.

10. A pair of axle welding alignment plates including:
(a) a first plate for clamping to an area adjacent a rocketship jig positioned about a replacement spindle on a first end of a vehicle axle outward of a plurality of outrigger clamps used during weld repair of the vehicle axle; and
(b) a second plate for affixing to a hub and spindle nut positioned on a second end of the vehicle axle opposite the first end, said first plate and said second plate having commonly spaced markings on at least one face of the first plate and one face of the second plate in order for an operator to rotate at least one of the first plate and the second plate for better positive camber and toe alignment.

11. The alignment plate pair of claim 10 wherein the first plate has commonly spaced markings on both an inward face and an outward face.

12. The alignment plate pair of claim 10 wherein the commonly spaced markings on the first plate and the second plate are numbered sequentially.

13. The alignment plate pair of claim 12 wherein the commonly spaced markings on the first plate and the second plate are numbered similar to that of a clock face having twelve hour indicators.

14. The alignment plate pair of claim 10 wherein the commonly spaced markings on the first plate and the second plate are lettered sequentially.

15. The alignment plate pair of claim 10, which further includes an indicating connector between the commonly spaced markings of the first plate and the second plate.

16. The alignment plate pair of claim 15 wherein the indicating connector includes an extendible measuring tape.

17. The alignment plate pair of claim 15 wherein the indicating connector includes a laser pointer.

18. A method for aligning opposed ends of a vehicle axle for a weld repair, said method comprising the steps of:
(a) providing a first plate for clamping to an area adjacent a rocket ship jig positioned about a replacement spindle on a first end of a vehicle axle outward of a plurality of outrigger clamps used during weld repair of the vehicle axle;
(b) providing a second plate for affixing to a hub and spindle nut positioned on a second end of the vehicle axle opposite the first end, said first plate and said second plate having commonly spaced markings on at least one face of the first plate and one face of the second plate; and
(c) rotating at least one of the first plate and the second plate until the two plate are sufficiently aligned prior to commencing any weld repair thereon.

19. The method of claim 18 wherein the commonly spaced markings on the first plate and the second plate are numbered sequentially.

20. The method of claim 18 wherein the commonly spaced markings on the first plate and the second plate are lettered sequentially.
